(19) United States
(12) Patent Application Publication
(10) Pub. No.: US 2013/0135300 A1
(43) Pub. Date: May 30, 2013

(54) ROAD IMAGE DRAWING DEVICE AND ROAD IMAGE DRAWING METHOD

(71) Applicant: Ken Miyamoto, Tokyo (JP)

(72) Inventor: Ken Miyamoto, Tokyo (JP)

(73) Assignee: Mitsubishi Electric Corporation, Tokyo (JP)

(21) Appl. No.: 13/814,558

(22) PCT Filed: Sep. 7, 2010
(86) PCT No.: PCT/JP10/05485

§ 371 Date: Feb. 6, 2013

(51) Int. Cl. G06T 11/20; G06T 15/00

(52) U.S. Cl. CPC G06T 11/20; G06T 15/00
USPC 345/419

(57) ABSTRACT

A road image drawing device including: a boundary determining unit for determining whether or not a node is located at a boundary between parcels when it is determined that the node is located at either a start point or an end point of a road; a start point, end point, and boundary road slope data acquiring unit for acquiring slope data which is calculated in advance when it is determined that the node is located at a boundary between parcels; and a drawing data processing unit for generating drawing data from both a calculated slope of the node or the slope data acquired by the start point, end point, and boundary road slope data acquiring unit, and road width data pre-stored therein, and for storing the drawing data therein.

### FIELD OF THE INVENTION

The present invention relates to a road image drawing device for and a road image drawing method of generating map information for three-dimensional display.

### BACKGROUND OF THE INVENTION

A conventional road image drawing method for three-dimensional display will be explained with reference to FIG. 13. Road nodes O, P, and Q, and road links which connect between them are shown in FIG. 13(a). Further, each road node is managed for each division which is called a parcel. The road nodes O and P are managed for a parcel R, and the road nodes P and Q are managed for a parcel S. In FIG. 13(b), a predetermined width is assigned to each of the road nodes O, P, and Q, and pairs of two nodes for width assignment O′ and O″, P′ and P″, and Q′ and Q″ are newly generated for the road nodes, respectively. Then, as shown in FIG. 13(c), polygons which connect among the newly-generated pairs of nodes for width assignment O′ and O″, P′ and P″, and Q′ and Q″ are generated, and a road image is finally drawn at the positions corresponding to the polygons, as shown in FIG. 13(d). Further, the assignment of a width to the road is carried out with respect to a direction of the bisector of the angle of the triangle which consists of the three road nodes.

In addition, patent reference 1 discloses a method of adding height information to an on-screen road image in which a width is assigned to each road to correct the road image by using the height information and generate map information in order to display the road image in which a width is assigned to each road in a three-dimensional manner which makes it easy for the user to recognize the structure and height of each road in the road image, and the current position. More specifically, the height information is generated on the basis of attribution information included in two-dimensional map information, and the slope of each road is calculated to correct the height information. Map information is then generated by using the corrected height information, and roads including two-level crossings and underground passages are displayed in a three-dimensional manner with a natural slope being added to each of the roads, so that map information which is easy for the user to recognize is generated.

### RELATED ART DOCUMENT

### Patent Reference

Patent reference 1: Japanese Unexamined Patent Application Publication No. 2001-305953

### SUMMARY OF THE INVENTION

Because the conventional road image drawing method is implemented as above, in order to carry out a width assignment on a road node, the road node on which the width assignment is to be carried out and another road node connected to the road node are required. A problem is therefore that because each road node is managed for each parcel and road image drawing is carried out independently for each parcel, a road display with an ambiguous connection relationship between road nodes is produced at a boundary between two parcels. For example, in the example shown in FIG. 13, because the road nodes O and P are managed for the parcel R and the road nodes P and Q are managed for the parcel S, the connection relationship between the road nodes becomes ambiguous at the boundary between the parcels R and S, and a discontinuous road display as shown in FIG. 14 is produced.

Further, while the map information generating method disclosed by patent reference 1 makes it possible to generate map information in which a natural slope is added to each road and which is easy to recognize, no method of establishing a match between adjacent road nodes is disclosed and hence a road display which provides a clear connection relation at any boundary between parcels cannot be produced.

The present invention is made in order to solve the above-mentioned problems, and it is therefore an object of the present invention to provide a technique of establishing a match between adjacent road links at a boundary between two parcels and displaying a road map which is drawn with a natural connection relation.

In accordance with the present invention, there is provided a road image drawing device including: a parcel data storage unit for dividing map data into map data of parcels each associated with a range enclosed by predetermined coordinates, and for storing drawing data for each of the parcels; a parcel data acquiring unit for acquiring drawing data of one parcel from the parcel data storage unit; a road node data acquiring unit for acquiring node data showing a node corresponding to a predetermined point on a road from the drawing data of one parcel acquired by the parcel data acquiring unit; a start point and end point determining unit for referring to the node data acquired by the road node data acquiring unit to determine whether or not the node is located at a start point or an end point of the road; a normal road slope calculating unit for calculating a slope of the node when the start point and end point determining unit determines that the node is located at neither the start point nor the end point; a boundary determining unit for determining whether or not the node is located at a boundary between parcels when the start point and end point determining unit determines that the node is located at either the start point or the endpoint of the road; a start point, end point and non-boundary road slope calculating unit for calculating the slope of the node when the boundary determining unit determines that the node is not located at any boundary between parcels; a start point, endpoint and boundary road slope data acquiring unit for acquiring slope data which is calculated in advance when the boundary determining unit determines that the node is located at a boundary between parcels; and a drawing data processing unit for generating drawing data from both the slope calculated by the normal road slope calculating unit, the slope calculated by the start point, end point and non-boundary road slope calculating unit, or the slope data acquired by the start point, endpoint and boundary road slope data acquiring unit, and road width data pre-stored therein, and for storing the drawing data therein.

Because the road image drawing device according to the present invention is constructed in such a way as to include the start point, end point and boundary road slope data acquiring unit for, when the boundary determining unit determines that a node is located at a boundary between parcels, acquiring the slope data of the node which is calculated in advance, the road image drawing device can establish a match between road links at any parcel boundary and can draw a plurality of road links while providing a natural connection relationship between road links.

### BRIEF DESCRIPTION OF THE FIGURES

FIG. 1 is a block diagram showing the structure of a road image drawing device in accordance with Embodiment 1;

FIG. 2 is a view showing an example of slope data stored in a slope data storage unit of the road image drawing device in accordance with Embodiment 1;

FIG. 3 is an explanatory drawing showing relationships among road nodes in the road image drawing device in accordance with Embodiment 1;

FIG. 4 is a flow chart showing the operation of the road image drawing device in accordance with Embodiment 1;

FIG. 5 is an explanatory drawing showing parcels, road nodes, and road links in the road image drawing device in accordance with Embodiment 1;

FIG. 6 is an explanatory drawing showing a relationship between characteristics of road nodes and a slope calculating unit in the road image drawing device in accordance with Embodiment 1;

FIG. 7 is a block diagram showing the structure of a road image drawing device in accordance with Embodiment 2;

FIG. 8 is a flow chart showing the operation of the road image drawing device in accordance with Embodiment 2;

FIG. 9 is an explanatory drawing showing parcels, road nodes, and road links in the road image drawing device in accordance with Embodiment 2;

FIG. 10 is an explanatory drawing showing parcels, road nodes, and road links in the road image drawing device in accordance with Embodiment 2;

FIG. 11 is an explanatory drawing showing a relationship between characteristics of road nodes and a slope calculating unit in the road image drawing device in accordance with Embodiment 2;

FIG. 12 is a view showing an example of slope data stored in a slope data storage unit of the road image drawing device in accordance with Embodiment 2;

FIG. 13 is an explanatory drawing showing a drawing method which a conventional road image drawing device uses; and

FIG. 14 is an explanatory drawing showing a result of drawing carried out by a conventional road image drawing device.

### EMBODIMENTS OF THE INVENTION

Hereafter, in order to explain this invention in greater detail, the preferred embodiments of the present invention will be described with reference to the accompanying drawings.

### Embodiment 1

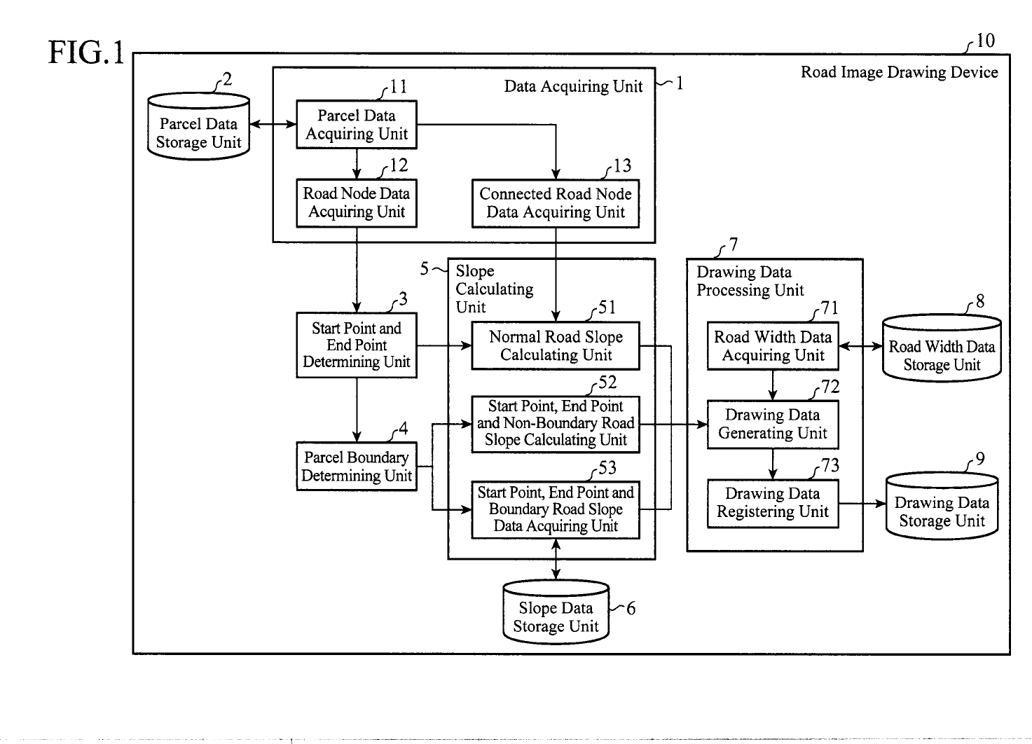

FIG. 1 is a block diagram showing the structure of a road image drawing device in accordance with Embodiment 1 of the present invention. The road image drawing device 10 is comprised of a data acquiring unit 1, a parcel data storage unit 2, a start point and end point determining unit 3, a parcel boundary determining unit 4, a slope calculating unit 5, a slope data storage unit 6, a drawing data processing unit 7, a road width data storage unit 8, and a drawing data storage unit 9. The data acquiring unit 1 is comprised of a parcel data acquiring unit 11, a road node data acquiring unit 12, and a connected road node data acquiring unit 13. The parcel data acquiring unit 11 acquires predetermined parcel data from the parcel data storage unit 2 for storing parcel data. The road node data acquiring unit 12 acquires data about a predetermined road node from the parcel data. The connected road node data acquiring unit 13 acquires data about road nodes connected to the predetermined road node in the road node data acquiring unit 12. The parcel data storage unit 2 divides map data into map data of parcels each associated with a predetermined area, and stores a set of data divided for each of the parcels therein.

The start point and end point determining unit 3 determines whether or not a target road node is a start point or an end point. The start point and end point determining unit carries out this determination by determining whether or not the target road node is connected to two other road nodes in the same parcel as that in which the target road node is included. The parcel boundary determining unit 4 determines that the target road node is located at a boundary between parcels when determining that the target road node satisfies either of the following conditions 1 to 4.

(the x coordinate of the road node)=(the x coordinate of the upper left corner of a parcel) Condition 1:

(the y coordinate of the road node)=(the y coordinate of the upper left corner of a parcel) Condition 2:

(the x coordinate of the road node)=(the x coordinate of the lower right corner of a parcel) Condition 3:

(the y coordinate of the road node)=(the y coordinate of the lower right corner of a parcel) Condition 4:

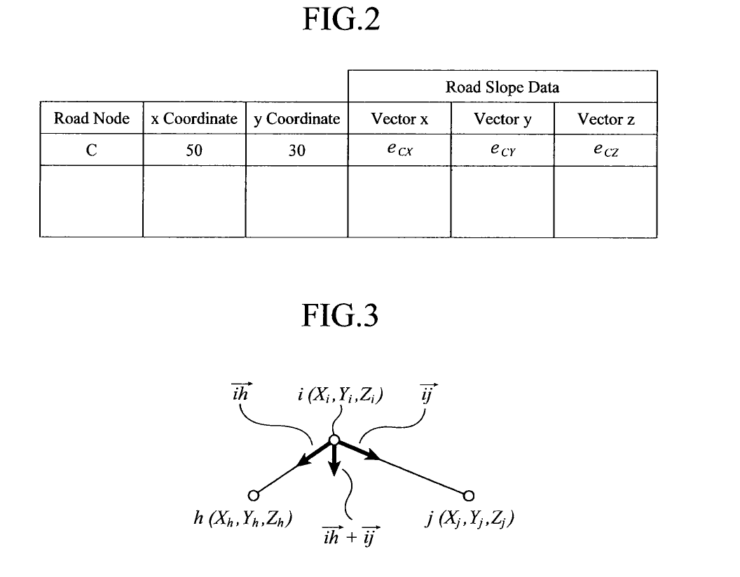

The slope calculating unit 5 is comprised of a normal road slope calculating unit 51, a start point, end point and non-boundary road slope calculating unit 52, and a start point, endpoint and boundary road slope data acquiring unit 53. When the target road node is neither a start point nor an end point and is not located at any boundary between parcels, the normal road slope calculating unit 51 calculates the slope of the target road node. When the target road node is a start point or an end point, but is not located at any boundary between parcels, the start point, endpoint and non-boundary road slope calculating unit 52 calculates the slope of the target road node. When the target road node is a start point or an end point, and is located at a boundary between parcels, the start point, end point and boundary road slope data acquiring unit 53 acquires the slope data of the road node from the slope data storage unit 6. The details of a method of calculating the slope which the normal road slope calculating unit 51 uses, and the details of a method of calculating the slope which the start point, end point and non-boundary road slope calculating unit 52 uses will be mentioned later. The slope data storage unit 6 stores road slope data about predetermined road nodes therein. FIG. 2 is a view showing an example of the road slope data stored in the slope data storage unit 6 in the road image drawing device in accordance with Embodiment 1. In the example shown in FIG. 2, the slope data storage unit stores the road slope data (e_{CX}, e_{CY}, e_{CZ}) of a road node C as well as the x and y coordinates of the road node C.

The drawing data processing unit 7 is comprised of a road width data acquiring unit 71, a drawing data generating unit 72, and a drawing data registering unit 73. The road width data acquiring unit 71 acquires the road width of the target road node from the road width data storage unit 8 for storing the road width of each road. The drawing data creating unit 72 generates road drawing data on the basis of both the road slope data inputted thereto from the normal road slope calculating unit 51, the start point, end point and non-boundary road slope calculating unit 52, or the start point, end point and boundary road slope data acquiring unit 53, and the road width data inputted thereto from the road width data acquiring unit 71. The details of a drawing data generating method which the drawing data generating unit 72 uses will be mentioned later. The drawing data registering unit 73 stores the road drawing data generated by the drawing data generating unit 72 in the drawing data storage unit 9.

Next, a slope calculating method which the slope calculating unit 5 uses will be explained. FIG. 3 is an explanatory drawing showing a connection relationship between road nodes in the road image drawing device in accordance with Embodiment 1. In FIG. 3, the target road node for slope calculation i (Xᵢ, Yᵢ, Zᵢ), and the road node h (Xₕ, Yₕ, Zₕ) and the road node j (Xⱼ, Yⱼ, Zⱼ) which are connected to the road node i are shown. The road node i corresponds to the road node on which the road node data acquiring unit 12 carries out the data acquisition, and the road nodes h and j are the ones with which the road node i has a connection relationship and on which the road node data acquiring unit 13 carries out the data acquisition. When the road node i is explained as an example, i shows the index of the road node and (Xᵢ, Yᵢ, Zᵢ) shows the x, y, and z coordinates of the road node i.

Next, the method of calculating the slope of the target road node will be explained with reference to FIG. 3. The calculation of the slope will be explained separately in a case (1) in which the road node i is a one of a normal road which is neither a start point nor an end point, in a case (2) in which the road node i is a start point or an end point, but is not located at a parcel boundary, and in a case (3) in which the road node i is a start point or an end point and is located at a parcel boundary.

In the case (1) in which the road node i is a one of a normal road which is neither a start point nor an end point The normal road slope calculating unit 51 calculates the slope of the road node i. The normal road slope calculating unit 51 determines a unit vector in a direction of the bisector of the angle formed by the three road nodes h, i, and j, and sets the unit vector as the slope data (e_{iX}, e_{iY}, e_{iZ}) of the road node i. Concretely, the normal road slope calculating unit acquires the data about the road nodes h and j which are connected to the road node i from the connected road node data acquiring unit 13 first. The normal road slope calculating unit then calculates a unit vector ih from the road node i to the road node h and a unit vector ij from the road node i to the road node j according to the following equation (a).

$$\begin{matrix}\vec{ih} = \frac{( \begin{matrix}{X}_{h} \\ {Y}_{h} \\ {Z}_{h}\end{matrix} ) ( \begin{matrix}{X}_{i} \\ {Y}_{i} \\ {Z}_{i}\end{matrix} )}{\vert ( \begin{matrix}{X}_{h} \\ {Y}_{h} \\ {Z}_{h}\end{matrix} ) - ( \begin{matrix}{X}_{i} \\ {Y}_{i} \\ {Z}_{i}\end{matrix} ) \vert} & equation ( a ) \text{-} 1 \\ \vec{ij} = \frac{( \begin{matrix}{X}_{j} \\ {Y}_{j} \\ {Z}_{j}\end{matrix} ) - ( \begin{matrix}{X}_{i} \\ {Y}_{i} \\ {Z}_{i}\end{matrix} )}{\vert ( \begin{matrix}{X}_{j} \\ {Y}_{j} \\ {Z}_{j}\end{matrix} ) - ( \begin{matrix}{X}_{i} \\ {Y}_{i} \\ {Z}_{i}\end{matrix} ) \vert} & equation ( a ) \text{-} 2\end{matrix}$$

Next, the normal road slope calculating unit calculates the sum of the unit vector ih and the unit vector ij to determine the unit vector in a direction of the bisector of the angle formed by the road nodes h, i, and j, and then calculates the slope data (e_{iX}, e_{iY}, e_{iZ}) of the road node i according to the following equation (b).

$$( \begin{matrix}{e}_{iX} \\ {e}_{iY} \\ {e}_{iZ}\end{matrix} ) = \frac{\vec{ih} + \vec{ij}}{\vert \vec{ih} + \vec{ij} \vert} \qquad equation ( b )$$

In the case (2) in which the road node i is a start point or an end point, but is not located at a parcel boundary

The start point, end point and non-boundary road slope calculating unit 52 calculates the slope of the road node i. In the example shown in FIG. 3, the road node i is a start point and the road node j is connected to the road node i. When the X coordinate Xᵢ of the road node i is not the same as the X coordinate Xⱼ of the road node j having a connection relationship with the road node i, the slope data (e_{iX}, e_{iY}, e_{iZ}) is set to (1, 0, 0), otherwise, i.e., when the coordinate Xᵢ is the same as the coordinates Xⱼ, the slope data (e_{iX}, e_{iY}, e_{iZ}) is set to (0, 1, 0).

In the case (3) in which the road node i is a start point or an end point and is located at a parcel boundary

The start point, end point and boundary road slope data acquiring unit 53 acquire the slope data (e_{iX}, e_{iY}, e_{iZ}) of the road node i from the slope data storage unit 6.

Next, a mechanism for carrying out a width assignment on a road by using the slope data (e_{iX}, e_{iY}, e_{iZ}) of the road calculated by the slope calculating unit 5, which the drawing data generating unit 72 of the drawing data processing unit 7 uses, will be explained. Coordinates Rᵢ and coordinates Pᵢ, which result from the width assignment carried out on the road node i, are calculated according to the following equation (c).

$$\begin{matrix}coordinates {R}_{i} \text{:} ( {R}_{iX} , {R}_{iY} , {R}_{iZ} ) = ( \begin{matrix}{X}_{i} + Rwidth * {e}_{iX} , \\ \begin{matrix}{Y}_{i} + Rwidth * {e}_{iY} , \\ {Z}_{i} + Rwidth * {e}_{iZ}\end{matrix}\end{matrix} ) \\ coordinates {P}_{i} \text{:} ( {P}_{iX} , {P}_{iY} , {P}_{iZ} ) = ( \begin{matrix}{X}_{i} - Rwidth * {e}_{iX} , \\ \begin{matrix}{Y}_{i} - Rwidth * {e}_{iY} , \\ {Z}_{i} - Rwidth * {e}_{iZ}\end{matrix}\end{matrix} )\end{matrix} \} \qquad equation ( c )$$

In the above-mentioned equation (c), Rᵢ (R_{iX}, R_{iY}, R_{iZ}) shows the x, y, and z coordinate values of the coordinates Rᵢ, and Pᵢ (P_{iX} P_{iY}, P_{iZ}) shows the x, y, and z coordinate values of the coordinates Pᵢ. Further, Rwidth shows the width of the road.

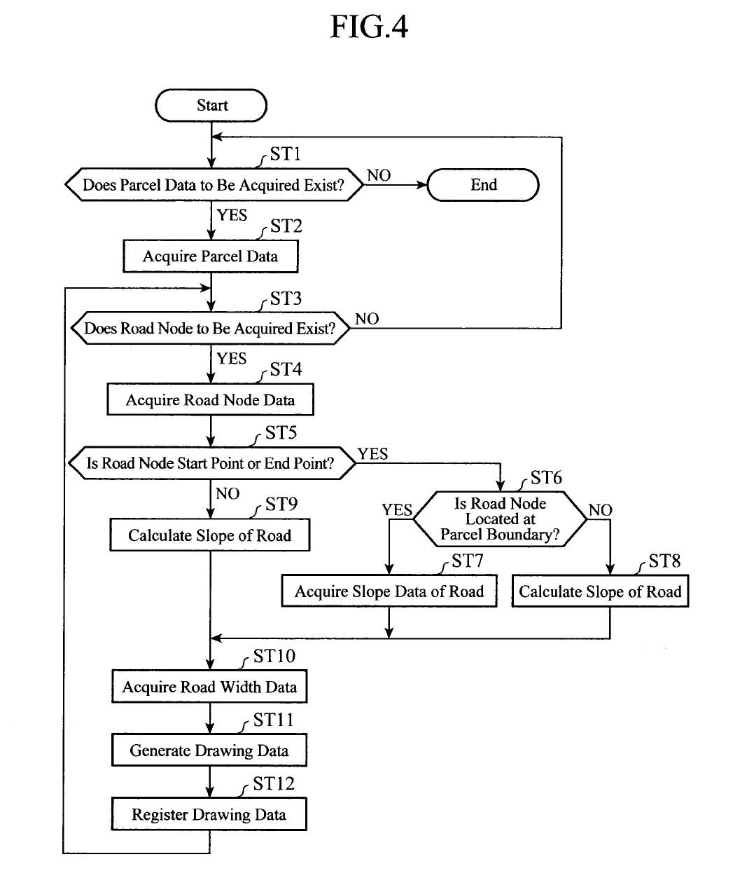

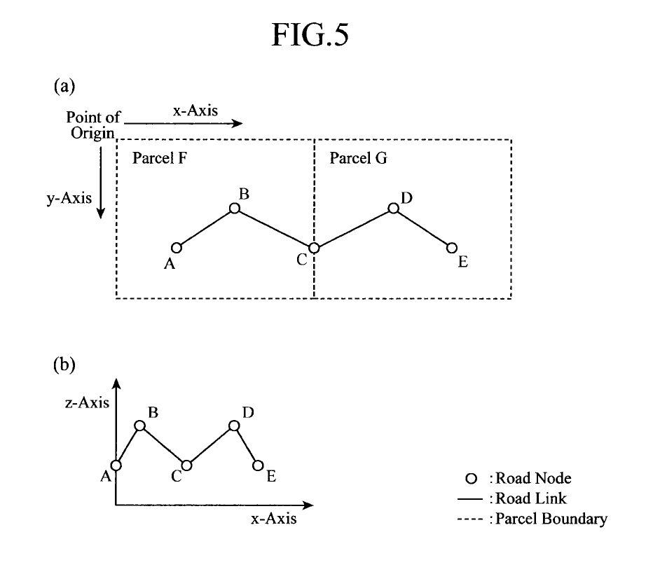

Next, the operation of the road image drawing device 10 in accordance with Embodiment 1 will be explained with reference to FIG. 4. FIG. 4 is a flow chart showing the operation of the road image drawing device in accordance with Embodiment 1. The parcel data acquiring unit 11 refers to the parcel data storage unit 2, and determines whether the parcel data which the parcel data acquiring unit has to acquire exists in the parcel data storage unit (step ST1). When determining that the parcel data which the parcel data acquiring unit has to acquire exists in the parcel data storage unit, the parcel data acquiring unit acquires the parcel data of one parcel and outputs this parcel data to the road node data acquiring unit 12 and the connected road node data acquiring unit 13 (step ST2). In contrast, when, in step ST1, determining that the parcel data which the parcel data acquiring unit has to acquire does not exist in the parcel data storage unit, the parcel data acquiring unit ends the processing.

The road node data acquiring unit 12 refers to the parcel data inputted thereto in step ST2 to determine whether the road node which the road node data acquiring unit has to acquire exists (step ST3). When determining that the road node which the road node data acquiring unit has to acquire exists, the road node data acquiring unit acquires the data about the road node which the road node data acquiring unit has to acquire (step ST4). The acquired data about the road node is outputted to the start point and end point determining unit 3 as the target for slope calculation. In contrast, when, in step ST3, determining that the road node which the road node data acquiring unit has to acquire does not exist, the road node data acquiring unit returns to the process of step ST1.

The start point and end point determining unit 3 refers to the inputted data about the target road node for slope calculation to determine whether or not the target road node is a start point or an end point (step ST5). When the start point and end point determining unit, in step ST5, determines that the target road node is a start point or an end point, the parcel boundary determining unit 4 refers to the data about this road node to determine whether or not the target road node is located at a parcel boundary (step ST6).

When the parcel boundary determining unit, in step ST6, determines that the target road node is located at a parcel boundary, the start point, end point, and boundary road slope data acquiring unit 53 refers to the slope data storage unit 6 to acquire the slope data of the target road node (step ST7) and then advances to a process of step ST10. In contrast, when the parcel boundary determining unit, in step ST6, determines that the target road node is not located at any parcel boundary, the start point, end point and non-boundary road slope calculating unit 52 refers to the X coordinate of the target road node and the X coordinates of the road nodes having a connection relationship with the target road node to calculate the slope of the road (step ST8), and then advances to the process of step ST10.

In contrast, when the start point and end point determining unit, in step ST5, determines that the target road node is neither a start point nor an end point, the normal road slope calculating unit 51 acquires the data about the road nodes which are connected to the target road node from the connected road node data acquiring unit 13 and calculates the slope of the road according to the above-mentioned equation (a) and (b) (step ST9), and then advances to the process of step ST10.

The road width data acquiring unit 71 of the drawing data processing unit 7 acquires the road width data of the target road node from the road width data storage unit 8, and outputs the road width data to the drawing data generating unit 72 (step ST10). The drawing data generating unit 72 acquires the coordinates resulting from the width assignment carried out on the road node according to the above-mentioned equation (c) to generate drawing data by using both the road width data inputted thereto in step ST10, and the slope data of the target road node inputted thereto in step ST7, ST8 or ST9, and outputs the drawing data to the drawing data registering unit 73 (step ST11). The drawing data registering unit 73 registers the drawing data inputted thereto in step ST11 in the drawing data storage unit (step ST12). After that, the road image drawing device returns the sequence shown in the flow chart to the process of step ST3, and then repeats the above-mentioned processing.

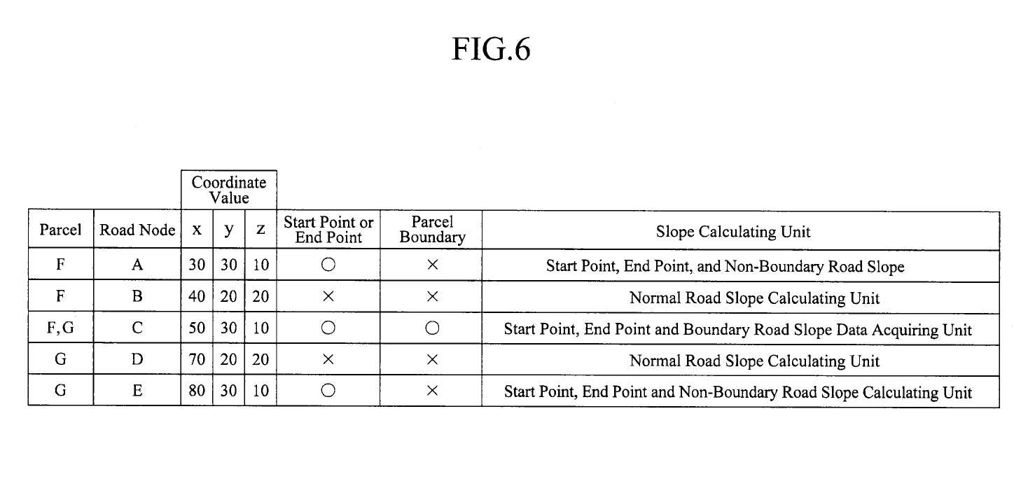

Next, an explanation will be made by using concrete coordinates shown in FIGS. 5 and 6 with reference to the flow chart shown in FIG. 4. First, the concrete example shown in FIGS. 5 and 6 will be explained. FIG. 5(a) shows a relationship between road nodes and road links in their x and y coordinates, and FIG. 5(b) shows a relationship between the road nodes and the road links in their x and z coordinates. FIG. 6 shows a relationship between characteristics of the road nodes shown in FIG. 5 and the slope calculating unit 5. In the example shown in FIGS. 5 and 6, a parcel F and a parcel G are included in a rectangle having a point of origin at an upper left vertex thereof and having a longitudinal width of 50 and a lateral width of 100, road nodes A, B, and C are managed for the parcel F and road nodes C, D, and E are managed for the parcel G, and a rectangle connecting the four points (0, 0), (0, 50), (50, 50), and (50, 0) is defined as the parcel boundary of the parcel F and a rectangle connecting the four points (50, 0), (50, 50), (100, 50), and (100, 0) is defined as the parcel boundary of the parcel G. In this case, the drawing data storage unit 9 can store up to 100 road nodes and up to 100 road links of drawing data, for example. Further, it is assumed that the road width is “5.”

The coordinates of the road node A are (30, 30, 10), the coordinates of the road node B are (40, 20, 20), the coordinates of the road node C are (50, 30, 10), the coordinates of the road node D are (70, 20, 20), and the coordinates of the road node E are (80, 30, 10). Further, the road links included in the parcel F are {A, B} and {B, C}, and the road links included in the parcel G are {C, D} and {D, E}. A relationship between each road node and the unit vector showing the slope of the road, which is stored in the slope data storage unit 6, is shown in FIG. 2. In the example shown in FIG. 2, the unit vector showing the slope of the road node C is stored, and this unit vector is the data calculated from the connection relationship between the road nodes which are connected to each other in such a way as to sandwich the boundary between the parcel F and the parcel G therebetween.

Next, the processing in the concrete example shown in FIGS. 5 and 6 will be explained. The parcel data acquiring unit 11, in step ST1, determines that the parcel F which is parcel data to be acquired exists, and, in step ST2, acquires the parcel data of the parcel F and outputs this parcel data to the road node data acquiring unit 12 and the connected road node data acquiring unit 13. The road node data acquiring unit 12, in step ST3, refers to the parcel data of the parcel F inputted thereto in step ST2 to determine that the road node A to be acquired exists, and, in step ST4, acquires the data about the road node A and outputs this data to the start point and end point determining unit 3.

The start point and endpoint determining unit 3, in step ST5, determines whether or not the road node A is a start point or an end point. Because only the road node B is connected to the road node A in this example, the start point and end point determining unit determines that the road node A is not connected to two road nodes and is a start point or an end point. The parcel boundary determining unit 4 then, in step ST6, determines whether or not the road node A is located at a parcel boundary. Because the road node A does not satisfy any one of the above-mentioned conditions 1 to 4, and is not located at any parcel boundary, the road map drawing device advances to step ST8. The start point, end point and non-boundary road slope calculating unit 52, in step ST8, calculates the slope of the road node A and outputs this slope data to the drawing data generating unit 72, and then advances to the process of step ST10.

Hereafter, the calculation of the slope of the road node A in step ST8 will be explained in detail. The start point, end point, and non-boundary road slope calculating unit 52 carries out the calculation of the slope of the road node A, and calculates the slope by comparing the X coordinate of the road node A with that of the road node B having a connection relationship with the road node A. The X coordinate of the road node A is “30”, and the X coordinate of the road node B is “40” in this example. Because the both X coordinates are not the same as each other, the start point, endpoint, and non-boundary road slope calculating unit calculates the slope data of the road node A as (e_{AX}, e_{AY}, e_{AZ})=(1, 0, 0). This calculated slope data (e_{AX}, e_{AY}, e_{AZ}) is outputted to the drawing data generating unit 72.

The road width data acquiring unit 71, in step ST10, acquires the road width data of the road node A from the road width data storage unit 8, and outputs this road width data to the drawing data generating unit 72. The drawing data generating unit 72, in step ST11, uses both the road width data of the road node A inputted thereto in step ST10, and the slope data of the road node A inputted thereto in step ST8 to carry out a width assignment using the above-mentioned equation (c) to calculate the coordinates RA(35, 30, 10) and the coordinates PA(25, 30, 10) of the road node A. The coordinates RA and the coordinates PA which are calculated are outputted to the drawing data registering unit 73 as drawing data. The drawing data registering unit 73, in step ST12, registers the drawing data in the drawing data storage unit 9. After that, the road image drawing device returns to the process of step ST3.

Next, processing carried out on the road node B will be explained. The road node data acquiring unit 12, in steps ST3 and ST4, acquires the data about the road node B in the parcel F, and outputs this data to the start point and end point determining unit 3. The start point and end point determining unit 3, in step ST5, determines whether or not the road node B is a start point or an end point. Because the road node B is connected to the road node A and the road node C in this example, the start point and end point determining unit determines that the road node B is neither a start point nor an end point, and then advances to step ST9.

The normal road slope calculating unit 51, in step ST9, acquires the data about the road nodes A and C connected to the road node B from the connected road node data acquiring unit 13, and calculates the slope of the road node B according to the above-mentioned equations (a) and (b). Concretely, the normal road slope calculating unit calculates a vector BA and a vector BC first (refer to result (a)-1 and result (a)-2). The normal road slope calculating unit then calculates a unit vector which is the sum of the vector BA and the vector BC as the slope data (e_{BX}, e_{BY}, e_{BZ}) of the road node B (refer to result (b)). The calculated slope data is outputted to the drawing data generating unit 72.

$$\begin{matrix}\vec{BA} = \frac{( \begin{matrix}30 \\ 30 \\ 10\end{matrix} ) - ( \begin{matrix}40 \\ 20 \\ 20\end{matrix} )}{( \begin{matrix}30 \\ 30 \\ 10\end{matrix} ) - ( \begin{matrix}40 \\ 20 \\ 20\end{matrix} ) \vert} = \frac{( \begin{matrix}- 10 \\ 10 \\ - 10\end{matrix} )}{\sqrt{300}} = ( \begin{matrix}- 1 / \sqrt{3} \\ 1 / \sqrt{3} \\ - 1 / \sqrt{3}\end{matrix} ) & result ( a ) \text{-} 1 \\ \vec{BC} = \frac{( \begin{matrix}50 \\ 30 \\ 10\end{matrix} ) - ( \begin{matrix}40 \\ 20 \\ 20\end{matrix} )}{( \begin{matrix}50 \\ 30 \\ 10\end{matrix} ) - ( \begin{matrix}40 \\ 20 \\ 20\end{matrix} ) \vert} = \frac{( \begin{matrix}10 \\ 10 \\ - 10\end{matrix} )}{\sqrt{300}} = ( \begin{matrix}1 / \sqrt{3} \\ 1 / \sqrt{3} \\ - 1 / \sqrt{3}\end{matrix} ) & result ( a ) \text{-} 2\end{matrix}$$

The road width data acquiring unit 71, in step ST10, acquires the road width data of the road node B from the road width data storage unit 8, and outputs the road width data to the drawing data generating unit 72. The drawing data generating unit 72, in step ST11, uses both the road width data of the road node B inputted thereto in step ST10 and the slope data of the road node B inputted thereto in step ST9 to carry out a width assignment using the above-mentioned equation (c) to calculate the coordinates RB and the coordinates PB of the road node B. The coordinates RB and the coordinates PB which are calculated are outputted to the drawing data registering unit 73 as drawing data. The drawing data registering unit 73, in step ST12, registers the drawing data in the drawing data storage unit 9. After that, the road image drawing device returns to the process of step ST3.

Next, processing carried out on the road node C will be explained. The road node data acquiring unit 12, in steps ST3 and ST4, acquires the data about the road node C in the parcel F, and outputs this data to the start point and end point determining unit 3. The start point and endpoint determining unit 3, in step ST5, determines whether or not the road node C is a start point or an end point. Because only the road node B is connected to the road node C in this example, the start point and end point determining unit determines that the road node C is not connected to two road nodes and is a start point or an end point.

The parcel boundary determining unit 4 then, in step ST6, determines whether or not the road node C is located at a parcel boundary. Because the road node C satisfies the above-mentioned condition 3 (the x coordinate of the road node C=the x coordinate of the lower right corner of the parcel F), and hence the parcel boundary determining unit determines that the road node C is located at a parcel boundary, the road image drawing device advances to step ST7. The start point, end point and boundary road slope data acquiring unit 53, in step ST7, acquires the slope data (e_{CX}, e_{CY}, e_{CZ}) of the road node C from the slope data storage unit 6, outputs this slope data to the drawing data generating unit 72, and then advances to the process of step ST10.

The road width data acquiring unit 71, in step ST10, acquires the road width data of the road node C from the road width data storage unit 8, and outputs the road width data to the drawing data generating unit 72. The drawing data generating unit 72, in step ST11, uses both the road width data of the road node C inputted thereto in step ST10 and the slope data of the road node C inputted thereto in step ST7 to carry out a width assignment using the above-mentioned equation (c) to calculate the coordinates RC and the coordinates PC of the road node C. The coordinates RC and the coordinates PC which are calculated are outputted to the drawing data registering unit 73 as drawing data. The drawing data registering unit 73, in step ST12, registers the drawing data in the drawing data storage unit 9. After that, the road image drawing device returns to the process of step ST3.

The road image drawing device completes the processes on all the road nodes included in the parcel F through the above-mentioned processing, and, in step ST3, determines that no road node to be acquired exists and returns to step ST1. After that, the road image drawing device, in steps ST1 and ST2, acquires the parcel data of the parcel G. The road image drawing device then carries out the process of generating drawing data on each of the road nodes C, D, and E included in the parcel G. Because the process of generating drawing data on each of the road nodes C, D, and E is the same as the above-mentioned process, the explanation of the process will be omitted.

As mentioned above, the road image drawing device according to this Embodiment 1 is constructed in such a way as to include the slope data storage unit 6 for storing the slope data of each road node located at a parcel boundary, and generate drawing data by using the slope data pre-stored in the slope data storage unit 6. Therefore, when drawing a road image independently for each parcel, the road image drawing device can establish a match between road links at any parcel boundary and can draw a plurality of road links while providing a natural connection relationship between road links even though a road node is located at a parcel boundary and therefore the road image drawing device cannot calculate the slope of the road node.

### Embodiment 2

Although in above-mentioned Embodiment 1 the mechanism for generating drawing data by using slope data pre-stored in the slope data storage unit 6 is shown, a mechanism for calculating the slope of each road node in advance by using a standardized calculating method without using stored slope data, and generating drawing data is shown in this Embodiment 2.

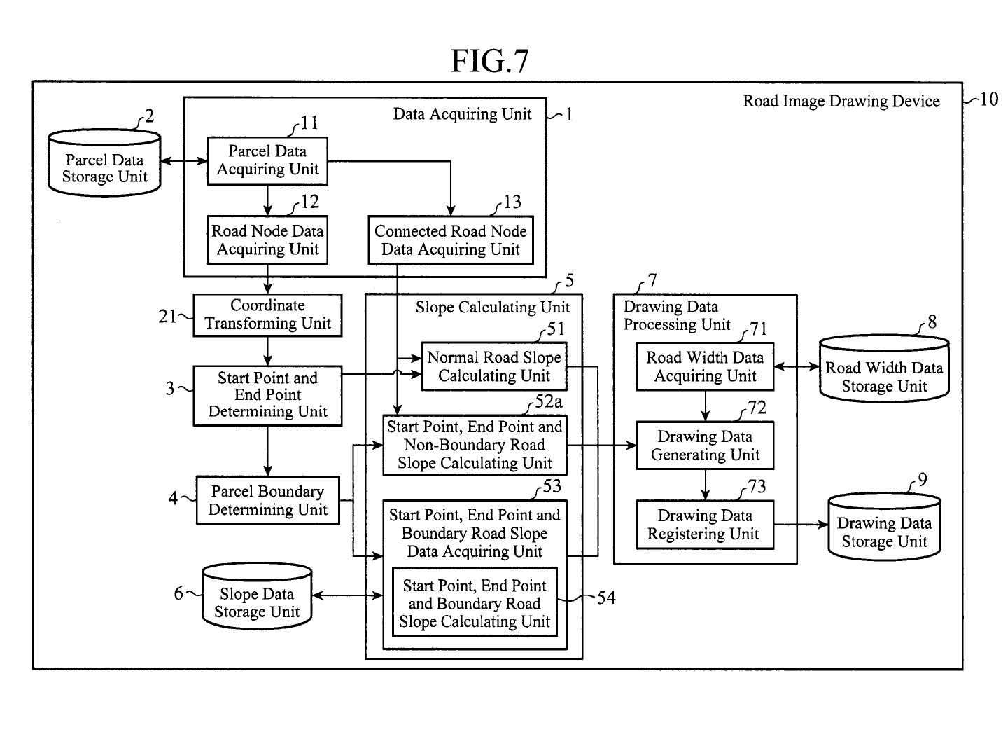

FIG. 7 is a block diagram showing the structure of a road image drawing device in accordance with Embodiment 2 of the present invention. In the road image drawing device according to this Embodiment 2, a coordinate transforming unit 21 is newly and additionally included in the road image drawing device 10 shown in Embodiment 1, and a start point, end point and boundary road slope calculating unit 54 is newly and additionally included in an end point and boundary road slope data acquiring unit 53. Further, a start point, end point and non-boundary road slope calculating unit 52a uses a slope calculating method different from that according to Embodiment 1. Hereafter, the same components as those of the road image drawing device 10 in accordance with Embodiment 1 or like components are designated by the same reference numerals as those used in Embodiment 1, and the explanation of the components will be omitted or simplified.

The coordinate transforming unit 21 transforms the coordinates of each road node in a parcel coordinate system which is used for managing data in each parcel into coordinates in a window coordinate system which is used for display. The coordinate transforming unit holds a matrix for transforming the coordinates of each road node in the parcel coordinate system into those in the window coordinate system.

A slope calculating unit 5 is comprised of a normal road slope calculating unit 51, the start point, end point and non-boundary road slope calculating unit 52a, and the start point, end point and boundary road slope data acquiring unit 53 having the start point, end point and boundary road slope calculating unit 54. The normal road slope calculating unit 51 is the same as that according to Embodiment 1, and, when a target road node is neither a start point nor an end point and is not located at any parcel boundary, calculates the slope of the target road node. When the target road node is a start point or an end point, but is not located at any parcel boundary, the start point, endpoint and non-boundary road slope calculating unit 52a calculates the slope of the target road node.

Because the slope calculating method which the start point, end point and non-boundary road slope calculating unit 52a uses differs from that according to Embodiment 1, the slope calculating method will be explained below. The explanation will be made with reference to FIG. 3 shown in Embodiment 1. The start point, end point and non-boundary road slope calculating unit 52a acquire data about a road node j having a connection relationship with the target road node i for slope calculation from a connected road node data acquiring unit 13 first. Next, the start point, end point and non-boundary road slope calculating unit calculates a unit vector (e_{iX}, e_{iY}, e_{iZ}) whose inner product with a vector ji connecting between the road node j and the road node i is zero according to the following equation (d). This unit vector (e_{iX}, e_{iY}, e_{iZ}) is defined as the slope data of the road node i.

$$ji \cdot ( \begin{matrix}{e}_{iX} \\ {e}_{iY} \\ {e}_{iZ}\end{matrix} ) = 0 \qquad equation ( d )$$

When the target road node is a start point or an end point and is located at a parcel boundary, the start point, end point and boundary road slope data acquiring unit 53 acquires the slope data of the road node. In performing the acquisition of the slope data, the start point, end point and boundary road slope data acquiring unit determines whether or not the slope data of the road node is stored in a road slope data storage unit 6 first, and, when the slope data of the road node is stored in the road slope data storage unit, acquires the road slope data from the road slope data storage unit 6. In contrast, when the slope data of the road node is not stored in the road slope data storage unit 6, the start point, end point and boundary road slope calculating unit 54 calculates the slope of the road node. When the road node satisfies the following condition 5, the start point, end point and boundary road slope calculating unit 54 sets the slope data (e_{iX}, e_{iY}, e_{iZ}) to (1, 0, 0), whereas when the road node satisfies the following condition 6, the start point, end point and boundary road slope calculating unit 54 sets the slope data (e_{iX}, e_{iY}, e_{iZ}) to (0, 1, 0).

(the x coordinate of the road node)=(the x coordinate of the upper left corner of a parcel) or (the x coordinate of the road node)=(the x coordinate of the lower right corner of a parcel) Condition 5:

(the y coordinate of the road node)=(the y coordinate of the upper left corner of a parcel) or (the y coordinate of the road node)=(the y coordinate of the lower right corner of a parcel) Condition 6:

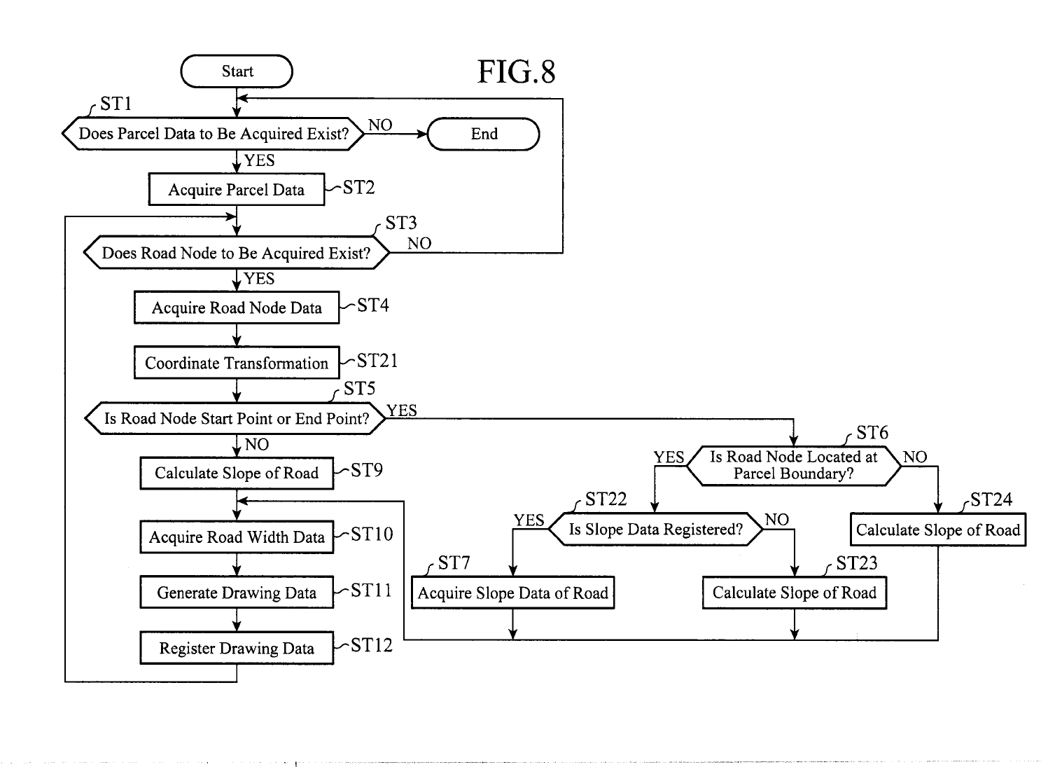

Next, the operation of the road image drawing device 10 in accordance with Embodiment 2 will be explained with reference to FIG. 8. FIG. 8 is a flow chart showing the operation of the road image drawing device in accordance with Embodiment 2. The same steps as those of the processing carried out by the road image drawing device 10 according to Embodiment 1 are designated by the same reference numerals as those used in FIG. 4, and the explanation of the steps will be omitted or simplified.

The road image drawing device acquires the data about the target road node through processes of steps ST1 to ST4. The data about the acquired road node is outputted to the coordinate transforming unit 21, and the coordinate transforming unit 21 transforms the coordinates of the road node in the parcel coordinate system into those in the window coordinate system (step ST21). The data about the coordinate-transformed road node is outputted to a start point and end point determining unit 3. The start point and end point determining unit 3 and a parcel boundary determining unit 4 determine whether or not the road node is a start point or an endpoint and also determine whether or not the road node is located at a parcel boundary (steps ST5 and ST6), respectively, like those according to Embodiment 1. When the start point and end point determining unit, in step ST5, determines that the road node is neither a start point nor an end point, the normal road slope calculating unit 51 calculates the slope of the road (step ST9) and then advances to a process of step ST10.

When the start point and end point determining unit and the parcel boundary determining unit, in steps ST5 and ST6, determine that the target road node is a start point or an end point and that the target road node is located at a parcel boundary, respectively, the start point, end point and boundary road slope data acquiring unit 53 determines whether or not the slope data of the road node is registered in the slope data storage unit 6 (step ST22). When, in step ST22, determining that the slope data of the road node is registered in the slope data storage unit, the start point, end point and boundary road slope data acquiring unit acquires the slope data of the road node from the slope data storage unit 6 (step ST7), and then advances to the process of step ST10. In contrast, when the start point, end point and boundary road slope data acquiring unit, in step ST22, determines that the slope data of the road node is not registered in the slope data storage unit, the start point, end point and boundary road slope calculating unit 54 calculates the slope of the road node according to which one of the above-mentioned conditions 5 and 6 is satisfied by the road node (step ST23), and then advances to the process of step ST10.

In contrast, when the start point and end point determining unit and the parcel boundary determining unit, in steps ST5 and ST6, determine that the target road node is a start point or an end point, and that the target road node is not located at any parcel boundary, respectively, the start point, end point and non-boundary road slope calculating unit 52a calculates the slope of the road according to the above-mentioned equation (d) (step ST24), and then advances to the process of step ST10. The road image drawing device, in steps ST10 to ST12, carries out the same processes as those shown in Embodiment 1 to generate and register drawing data.

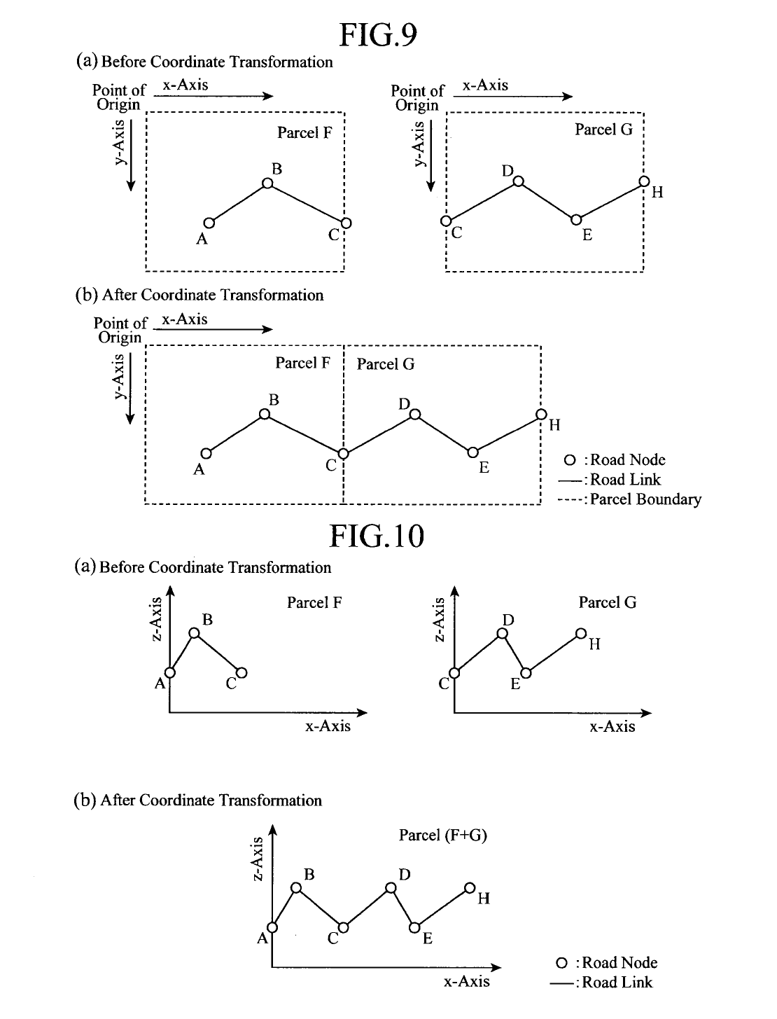

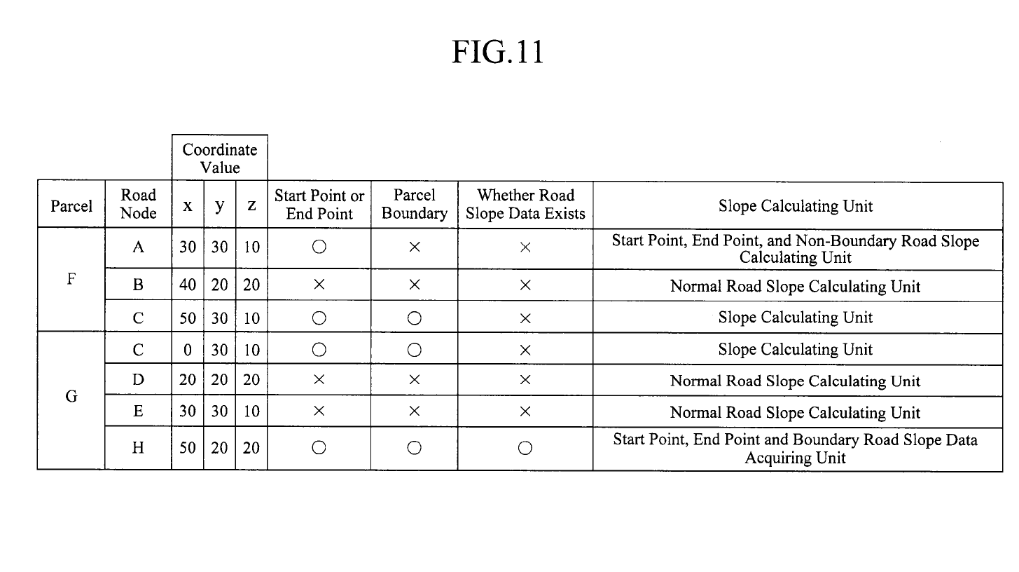

Next, an explanation will be made by using concrete coordinates shown in FIGS. 9, 10, and 11 with reference to a flow chart shown in FIG. 8. First, the concrete example shown in FIGS. 9, 10, and 11 will be explained. FIG. 9 shows a relationship between road nodes and road links in their x and y coordinates, FIG. 9(a) shows each parcel data yet to be coordinate-transformed, and FIG. 9(b) shows integrated parcel data coordinate-transformed. FIG. 10 shows a relationship between road nodes and road links in their x and z coordinates, FIG. 10(a) shows each parcel data yet to be coordinate-transformed, and FIG. 10(b) shows integrated parcel data coordinate-transformed. FIG. 11 shows a relationship between characteristics of the road nodes shown in FIGS. 9 and 10 and the slope calculating unit 5.

In the example shown in FIG. 9, two parcels F and G are included in a rectangle having a point of origin at an upper left vertex thereof and having a longitudinal width of 50 and a lateral width of 100, road nodes A, B, and C are managed for the parcel F and road nodes C, D, E, and H are managed for the parcel G. As shown in FIG. 11, the road nodes in the parcel coordinate system which are included in the parcel F are A(30, 30, 10), B(40, 20, 20), and C(50, 30, 10), and the road nodes in the parcel coordinate system which are included in the parcel G are C(0, 30, 10), D(20, 20, 20), E(30, 30, 10), and H(50, 20, 20).

When a matrix for transforming coordinates in the parcel coordinate system of the parcel F into those in the window coordinate system is expressed as MatF, and a matrix for transforming coordinates in the parcel coordinate system of the parcel G into those in the window coordinate system is expressed as MatG, the coordinate transforming unit 21 transforms the coordinates of the road nodes included in the parcel F into the coordinates A(30, 30, 10), B(40, 20, 20), and C(50, 30, 10) in the window coordinate system by using MatF, and also transforms the coordinates of the road nodes included in the parcel G into the coordinates C(50, 30, 10), D(70, 20, 20), E(80, 30, 10), and H (100, 20, 20) in the window coordinate system by using MatG. Further, the road links included in the parcel F are {A, B} and {B, C}, and the road links included in the parcel G are {C, D} and {D, E}.

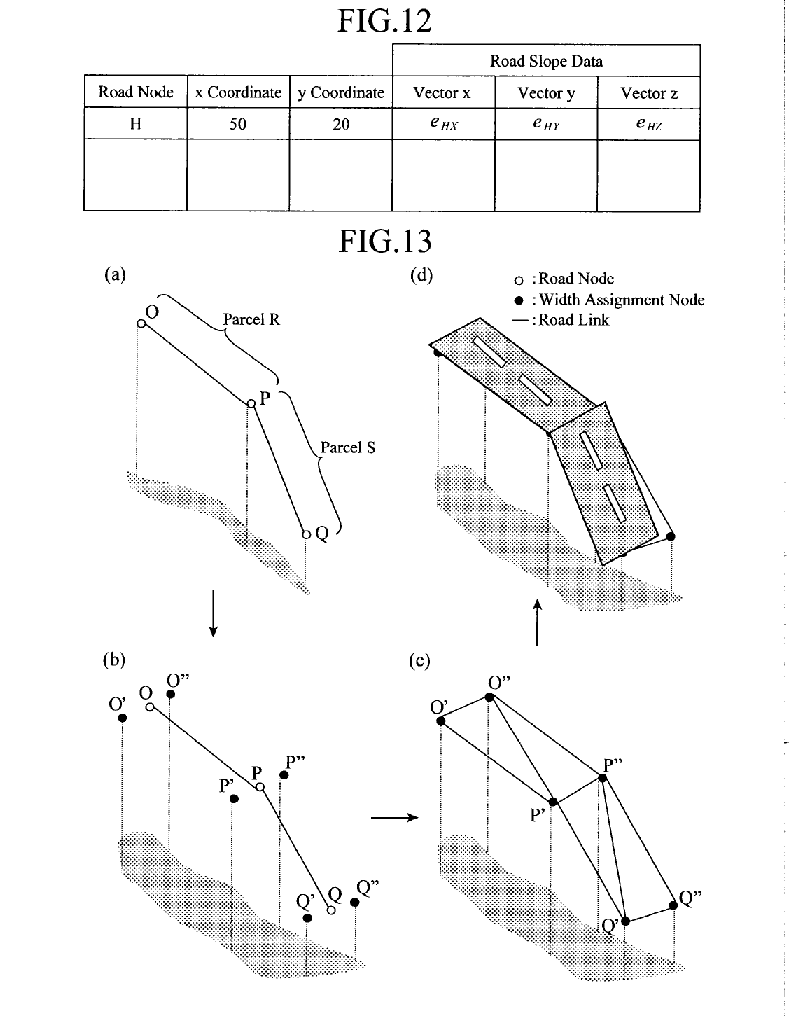

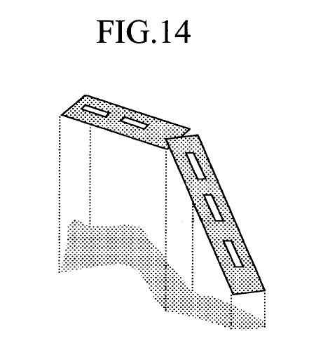

A rectangle connecting the four points (0, 0), (0, 50), (50, 50), and (50, 0) is defined as the parcel boundary of the parcel F expressed in the window coordinate system, and a rectangle connecting the four points (50, 0), (50, 50), (100, 50), and (100, 0) is defined as the parcel boundary of the parcel G expressed in the window coordinate system. In this case, a drawing data storage unit 9 can store up to 100 road nodes and up to 100 road links of drawing data, for example. Further, a relationship between each road node which is stored in the slope data storage unit 6 and the unit vector showing the slope of the road is shown in FIG. 12. In the example shown in FIG. 12, the unit vector (e_{HX}, e_{HY}, e_{HZ}) showing the slope of the road node H is stored.

Next, the processing using the concrete example shown in FIGS. 9, 10, 11, and 12 will be explained. A parcel data acquiring unit 11, in step ST1, determines that the parcel F shown by the parcel data which the parcel data acquiring unit has to acquire exists, and, in step ST2, acquires the parcel data of the parcel F and outputs the parcel data to a road node data acquiring unit 12 and the connected road node data acquiring unit 13. The road node data acquiring unit 12, in step ST3, refers to the parcel data of the parcel F inputted thereto in step ST2 to determine that the road node A which the road node data acquiring unit has to acquire exists, and, in step ST4, acquires the data about the road node A and outputs the data to the coordinate transforming unit 21.

The coordinate transforming unit 21, in step ST21, transforms the coordinates of the road node A in the parcel coordinate system into those in the window coordinate system by using the matrix MatF. In the case of the road node A, the coordinates do not vary before and after the coordinate transformation. The start point and endpoint determining unit 3 and the parcel boundary determining unit 4, in steps ST5 and ST6, determine that the road node A is a start point or an end point, and that the road node A is not located at any parcel boundary, respectively. Next, the start point, end point and non-boundary road slope calculating unit 52a, in step ST24, calculates the slope of the road node A, outputs the slope data to a drawing data generating unit 72, and then advances to the process of step ST10.

The calculation of the slope of the road node A in step ST24 will be explained in detail. The start point, end point and non-boundary road slope calculating unit 52a acquires the data about the road node B having a connection relationship with the road node A from the connected road node data acquiring unit 13. The start point, end point and non-boundary road slope calculating unit then calculates a unit vector (e_{AX}, e_{AY}, e_{AZ}) whose inner product with a vector BA connecting between the road node B and the road node A is zero by using the above-mentioned equation (d). As shown in the following result (d), the start point, end point and non-boundary road slope calculating unit calculates the vector BA from the coordinate values of the road nodes A and B, and sets the unit vector (e_{AX}, e_{AY}, e_{AZ}) which is the road slope data to (a, b, 0) by setting eAZ to 0 in such a way that the unit vector is parallel to the xy plane. Because the inner product of the vector BA and the unit vector (e_{AX}, e_{AY}, e_{AZ}) is zero, the slope data is calculated as (e_{AX}, e_{AY}, e_{AZ})=(½, ½, 0).

$$\vec{BA} = ( \begin{matrix}- 1 / \sqrt{3} \\ 1 / \sqrt{3} \\ - 1 / \sqrt{3}\end{matrix} ) \vert ( \begin{matrix}{e}_{iX} \\ {e}_{iY} \\ {e}_{iZ}\end{matrix} ) \vert = 1$$

$$( \begin{matrix}{e}_{iX} \\ {e}_{iY} \\ {e}_{iZ}\end{matrix} ) = ( \begin{matrix}a \\ b \\ 0\end{matrix} )$$

$$\vec{BA} = ( \begin{matrix}{e}_{iX} \\ {e}_{iY} \\ {e}_{iZ}\end{matrix} ) = - \frac{1}{\sqrt{3}} a + \frac{1}{\sqrt{3}} b = 0$$

Using these equations yields

$$( \begin{matrix}{e}_{iX} \\ {e}_{iY} \\ {e}_{iZ}\end{matrix} ) = ( \begin{matrix}1 / 2 \\ 1 / 2 \\ 0\end{matrix} ) \qquad result ( d )$$

The calculated slope data (e_{AX}, e_{AY}, e_{AZ}) is outputted to the drawing data generating unit 72, and generation and registration of drawing data are carried out through the processes of steps ST10 to ST12.

Next, processing carried out on the road node B will be explained. The road node data acquiring unit 12, in steps ST3 and ST4, acquires the data about the road node B in the parcel F, and outputs this data to the coordinate transforming unit 21. The coordinate transforming unit 21, in step ST21, transforms the coordinates of the road node B in the parcel coordinate system into those in the window coordinate system by using the matrix MatF. In the case of the road node B, the coordinates do not vary before and after the coordinate transformation. The start point and endpoint determining unit 3, in step ST5, determines that the road node B is neither a start point nor an end point and then advances to a process of step ST9.

The normal road slope calculating unit 51, in step ST9, acquires the data about the road nodes A and C connected to the road node B from the connected road node data acquiring unit 13, and calculates the slope of the road node B according to the above-mentioned equations (a) and (b). The computed results are the same as result (a)-1 and result (a)-2 which are shown in Embodiment 1. The calculated slope data (e_{BX}, e_{BY}, e_{BZ}) is outputted to the drawing data generating unit 72. The drawing data processing unit 7 generates and registers drawing data by using the calculated slope data (e_{BX}, e_{BY}, e_{BZ}) through the processes of steps ST10 to ST12.

Next, processing carried out on the road node C will be explained. The road node data acquiring unit 12, in steps ST3 and ST4, acquires the data about the road node C in the parcel F, and outputs this data to the coordinate transforming unit 21. The coordinate transforming unit 21, in step ST21, transforms the coordinates of the road node C in the parcel coordinate system into those in the window coordinate system by using the matrix MatF. In the case of the road node C, the coordinates do not vary before and after the coordinate transformation. The start point and end point determining unit 3 and the parcel boundary determining unit 4, in steps ST5 and ST6, determines that the road node A is a start point or an end point, and that the road node A is located at a parcel boundary, respectively. The start point, end point and boundary road slope data acquiring unit then, in step ST22, determines whether or not the slope data of the road node C is registered in the slope data storage unit 6. Because the slope data of the road node C is not registered in the slope data storage unit 6, the start point, end point and boundary road slope calculating unit 54, in step ST23, calculates the slope of the road node C, as shown in FIG. 12.

Concretely, because the road node C satisfies the above-mentioned condition 5 (the x coordinate of the road node C=the X coordinate of the lower right corner of the parcel F), the road slope data is calculated as (e_{CX}, e_{CY}, e_{CZ})=(1, 0, 0). The calculated slope data is outputted to the drawing data generating unit 72. The drawing data processing unit 7 generates and registers drawing data by using the calculated slope data (e_{CX}, e_{CY}, e_{CZ}) through the processes of steps ST10 to ST12.

Because the road image drawing device completes the processing on all the road nodes included in the parcel F through the above-mentioned processes, the road image drawing device, in step ST3, determines that no more road node which the road image drawing device has to acquire exists and returns to step ST1. The road image drawing device then, in steps ST1 and ST2, acquires the parcel data of the parcel G. The road image drawing device carries out the process of generating drawing data on each of the road nodes C, D, E, and H included in the parcel G. Because the process of generating drawing data for each of the road nodes C, D, E, and H is the same as the above-mentioned process, the explanation of this process will be omitted hereafter.

Next, processing carried out on the road node H in the parcel G will be explained. The road node data acquiring unit 12, in steps ST3 and ST4, acquires the data about the road node H in the parcel G, and outputs this data to the coordinate transforming unit 21. The coordinate transforming unit 21, in step ST21, transforms the coordinates of the road node H in the parcel coordinate system into those in the window coordinate system by using the matrix MatG. Concretely, the parcel coordinates (50, 20, 20) of the road node H are transformed into the window coordinates (100, 20, 20).

The start point and end point determining unit 3, in step ST5, determines whether or not the road node H is a start point or an end point. In this case, because only the road node E is connected to the road node H, the start point and end point determining unit determines that the road node H is not connected to two road nodes, and is a start point or an end point. Next, the parcel boundary determining unit 4, in step ST6, determines whether or not the road node H is located at a parcel boundary. Because the road node H satisfies the above-mentioned condition 3 (the x coordinate of the road node H=the x coordinate of the lower right corner of the parcel G), and hence the parcel boundary determining unit determines that the road node H is located at a parcel boundary, the parcel boundary determining unit advances to the process of step ST22.

The start point, end point and boundary road slope data acquiring unit then, in step ST22, determines whether or not the slope data of the road node H is registered in the slope data storage unit 6. Because the slope data of the road node H is registered in the slope data storage unit 6, as shown in FIG. 12, the start point, end point and boundary road slope data acquiring unit 53, in step ST7, acquires the slope data (e_{HX}, e_{HY}, e_{HZ}) of the road node H from the slope data storage unit 6 and outputs this slope data to the drawing data generating unit 72. The drawing data processing unit 7 generates and registers drawing data by using the calculated slope data (e_{HX}, e_{HY}, e_{HZ}) through the processes of steps ST10 to ST12.

Because the road image drawing device completes the processing on all the road nodes included in the parcel F through the above-mentioned processes, the road image drawing device, in step ST3, determines that no more road node which the road image drawing device has to acquire exists and returns to step ST1. The road image drawing device further determines that no more parcel data which the road image drawing device has to acquire in step ST1 exists, and ends the processing.

As mentioned above, because the road image drawing device according to this Embodiment 2 is constructed in such a way as to include the start point, end point and boundary road slope calculating unit 54 for, when the slope data of a road node located at a parcel boundary is not stored in the slope data storage unit 6, calculating the slope of the road node in advance according to the standardized calculating method, the road image drawing device can establish a match between road links at any parcel boundary and can draw a plurality of road links while providing a natural connection relationship between road links even though a road node is located at a parcel boundary and therefore the road image drawing device cannot acquire the slope data of the road node.

Further, the road image drawing device according to this Embodiment 2 is constructed in such a way as to include the coordinate transforming unit for carrying out a coordinate transformation from the parcel coordinate system to the window coordinate system, the road image drawing device can provide the same advantage also when using road data which requires the coordinate transformation. It is further understood that a combination of the embodiments can be made and changes and omissions can be made in the present invention within the scope of the present invention.

### INDUSTRIAL APPLICABILITY

Because the road image drawing device and the road image drawing method in accordance with the present invention can draw a plurality of road links while providing a natural connection relationship between road links when drawing a road image in a three-dimensional manner, the road image drawing device and the road image drawing method in accordance with the present invention can be used for providing the user with an image display which is easy to visually recognize in a navigation device or the like.

1. A road image drawing device comprising:
a parcel data storage unit for dividing map data into map data of parcels each associated with a range enclosed by predetermined coordinates, and for storing drawing data for each of said parcels;
a parcel data acquiring unit for acquiring drawing data of one parcel from said parcel data storage unit;
a road node data acquiring unit for acquiring node data showing a node corresponding to a predetermined point on a road from the drawing data of one parcel acquired by said parcel data acquiring unit;
a start point and end point determining unit for referring to said node data acquired by said road node data acquiring unit to determine whether or not said node is located at a start point or an end point of the road;
a normal road slope calculating unit for calculating a slope of said node when said start point and end point determining unit determines that said node is located at neither the start point nor the end point;
a boundary determining unit for determining whether or not said node is located at a boundary between parcels when said start point and end point determining unit determines that said node is located at either the start point or the end point of the road;
a start point, end point and non-boundary road slope calculating unit for calculating the slope of said node when said boundary determining unit determines that said node is not located at any boundary between parcels;
a start point, end point and boundary road slope data acquiring unit for acquiring slope data which is calculated in advance when said boundary determining unit determines that said node is located at a boundary between parcels; and
a drawing data processing unit for generating drawing data from both the slope calculated by said normal road slope calculating unit, the slope calculated by said start point, end point and non-boundary road slope calculating unit, or the slope data acquired by said start point, end point and boundary road slope data acquiring unit, and road width data pre-stored therein, and for storing the drawing data therein.

2. The road image drawing device according to claim 1, wherein said slope data is calculated in advance on a basis of a connection relationship between nodes which are located in a plurality of parcels which form said parcel boundary and which are connected to each other in such a way as to sandwich said boundary between them.

3. The road image drawing device according to claim 1, wherein the normal road slope calculating unit calculates, as the slope, a unit vector on a bisector of an angle formed by the node which said start point and end point determining unit determines is located at neither said start point nor said end point, and two nodes connected to said node.

4. The road image drawing device according to claim 1, wherein said road image drawing device includes a coordinate transforming unit for transforming coordinates of the node data acquired by said road node data acquiring unit, the coordinates being managed independently for each of the parcels, into coordinates used for managing said node data as drawing data which are generated by a combination of said parcels.

5. The road image drawing device according to claim 1, wherein said start point, end point and boundary road slope data acquiring unit includes a start point, end point and boundary road slope calculating unit for, when no slope data corresponding to a predetermined node exists, applying a fixed slope which is calculated in advance to said predetermined road node according to where in a parcel boundary said predetermined road node is located.

6. A road image drawing method comprising:
a parcel data acquiring step of acquiring drawing data of one parcel included in parcels each associated with a range of map data enclosed by predetermined coordinates; a node data acquiring step of acquiring node data showing a node corresponding to a fixed point from said drawing data of one parcel;
a start point and end point determining step of referring to said node data to determine whether or not said node is located at a start point or an end point of a road;
a normal road slope calculating step of calculating a slope of said node when said node is located at neither the start point nor the end point;
a boundary determining unit of determining whether or not said node is located at a boundary between parcels when said node is located at either the start point or the end point of the road;
a start point, end point and non-boundary road slope calculating step of calculating the slope of said node when said node is not located at any boundary between parcels;
a start point, end point and boundary road slope data acquiring step of acquiring slope data which is calculated in advance when said node is located at a boundary between parcels; and
a drawing data processing step of generating drawing data from both said calculated slope or said acquired slope data, and road width data pre-stored therein, and for storing the drawing data therein.
